(19) United States
(12) Patent Application Publication
(10) Pub. No.: US 2020/0076243 A1
(43) Pub. Date: Mar. 5, 2020

(54) WIRELESS CHARGING APPARATUS FOR STABILIZING WIRELESS CHARGING PERFORMANCE

(71) Applicant: Che-Min Wu, Torrance, CA (US)

(72) Inventor: Che-Min Wu, Torrance, CA (US)

(21) Appl. No.: 16/560,854

(22) Filed: Sep. 4, 2019

Related U.S. Application Data
(60) Provisional application No. 62/726,927, filed on Sep. 4, 2018.

(51) Int. Cl. H02J 50/40; H02J 7/02; H02J 7/00; H04B 5/00

(52) U.S. Cl. CPC H02J 50/40; H04B 5/0037; H02J 7/0042; H02J 7/025

(57) ABSTRACT

A wireless charging apparatus may include a power supply, a first wireless charging transmitter and a first wireless charging receiver, wherein the power supply is configured to supply power to the first wireless charging transmitter, and the first wireless charging transmitter comprises a circuit board, a first wireless transmitting coil, a first magnet and a first metal cover, wherein the circuit board is connected to the first wireless transmitting coil, a periphery of the first magnet is sleeved with the first metal cover and is connected with the first metal cover; the first wireless charging receiver comprises a first wireless receiving coil, a second magnet and a second metal cover, a periphery of the second magnet is sleeved and connected with the second metal cover, and the first wireless transmitting coil coordinates with the first wireless receiving coil to wirelessly charge the first wireless charging receiver.

### FIELD OF THE INVENTION

The present invention relates to a structure for stabilizing wireless charging performance, a wireless charging apparatus and a vehicle-mounted wireless charging apparatus.

### BACKGROUND OF THE INVENTION

Conventionally, the wireless charging technique includes a magnet in a wireless charging base, and the setting of magnet is convenient for the wireless charger to be connected with an electronic equipment stably; however, the setting of the magnet interferes with the magnetic field in the wireless charging base and adversely affects the charging performance, causing irregular or abnormal charging activity and poor charging effect, etc. Therefore, a new and improved wireless charging apparatus are needed to overcome the problems stated above.

### SUMMARY OF THE INVENTION

In order to overcome the problems stated above, the present invention provides a structure for stabilizing wireless charging performance, a wireless charging apparatus and a vehicle-mounted wireless charging apparatus, which may include a power supply, a first wireless charging transmitter and a first wireless charging receiver, wherein the power supply is configured to supply power to the entire first wireless charging transmitter, and the first wireless charging transmitter comprises a circuit board, a first wireless transmitting coil, a first magnet and a first metal cover, wherein the circuit board is connected to the first wireless transmitting coil, a periphery of the first magnet is sleeved with the first metal cover and is connected with the first metal cover; the first wireless charging receiver comprises a first wireless receiving coil, a second magnet and a second metal cover, a periphery of the second magnet is sleeved and connected with the second metal cover, the first wireless charging receiver is snap-connected to the first wireless charging receiver via the first magnet and the second magnet, and the first wireless transmitting coil coordinates with the first wireless receiving coil to wirelessly charge the first wireless charging receiver.

In one embodiment, the first metal cover and the second metal cover each comprises a bottom cover, a side wall and a top cover, wherein the side wall is disposed between the bottom cover and the top cover, and the bottom cover, the side wall and the top cover are integrally formed.

In another embodiment, the first metal cover and the second metal cover each comprise a bottom cover and a side wall, and the bottom cover and the side wall are integrally formed.

In still another embodiment, the bottom cover is disposed near one end of the first wireless transmitting coil; and the bottom cover is disposed near one end of the first wireless receiving coil.

In a further embodiment, the material of the first metal cover is steel or iron or aluminum or copper or zinc, and the material of the second metal cover is steel or iron or aluminum or copper or zinc.

In still another embodiment, the number of the first magnets is equal to the number of the second magnets, and the number of the first magnets is one or more, and the number of the first magnets is equal to the number of the second magnets, and the number of the first magnets is four.

In another aspect, the present invention provides a wireless charging apparatus, comprising a structure for stabilizing wireless charging performance and a wireless charging housing, wherein a battery is provided in the wireless charging housing, the power supply is configured to supply electricity to the battery, the battery is electrically connected to the first wireless transmitting coil, the first magnet and the first metal cover are disposed on a surface shell of the wireless charging housing, and the first wireless charging receiver comprises an electronic equipment for receiving wireless charging and a housing for accommodating the electronic equipment; the first wireless receiving coil is disposed in the electronic equipment, and both the second magnet and the second metal cover are disposed on a bottom plate of the housing.

In a further aspect, the present invention provides a vehicle-mounted wireless charging apparatus, comprising a structure for stabilizing wireless charging performance, a wireless charging housing and a base, wherein the base comprises a connecting shaft and a spring clip connected to a vehicle, the connecting base is connected with the spring clip, a rotating shaft is arranged at the bottom shell of the wireless charging housing, and the connecting shaft is connected with the rotating shaft; a power input interface is disposed in the wireless charging housing, the power supply charges the first wireless transmitting coil via the power input interface, the first magnet and the first metal cover are both disposed on the surface shell of the wireless charging housing, and the first wireless charging receiver comprises an electronic equipment for receiving wireless charging and a housing for accommodating the electronic equipment, the first wireless receiving coil is disposed in the electronic equipment, the second magnet and the second metal cover are both disposed on the bottom plate of the housing.

In a further embodiment, the mobile phone can be attached to the wireless charging apparatus through micro suction. More specifically, a pair of elongated stripes on a front surface of a wireless charging apparatus are used for attaching a mobile device to the front surface of the wireless charging apparatus through micro suction. Alternatively, the elongated stripes can be expanded to a wider piece to provide a stronger suction force to the mobile device. In still an alternative embodiment, the entire front surface can be used for micro suction to hold the mobile device on the wireless charging apparatus.

The present invention is advantageous because it can achieve the following beneficial effects: for the structure for stabilizing wireless charging performance, the periphery of the first magnet is sleeved with a first metal cover, making the magnetic field generated by the first wireless charging transmitter not to interfere with the magnetic field generated by the first magnet; and the periphery of the second magnet is sleeved with a second metal cover, making the magnetic field generated by the first wireless charging receiver not to interfere with the magnetic field generated by the second magnet, thereby stabilizing the wireless charging performance of the product.

### BRIEF DESCRIPTION OF THE DRAWINGS

FIG. 1 is a schematic structural diagram of a wireless charging apparatus of the present invention.

FIG. 2 is a schematic structural diagram of a vehicle-mounted wireless charging apparatus of the present invention.

FIG. 3 is an exploded view I of a wireless charging apparatus of the present invention.

FIG. 4 is an exploded view II of a wireless charging apparatus of the present invention.

FIG. 5 is an exploded view I of a vehicle-mounted wireless charging apparatus of the present invention.

FIG. 6 is an exploded view II of a vehicle-mounted wireless charging apparatus of the present invention.

FIGS. 7a to 7e illustrates schematic views of the arrangement of magnets in the wireless charging apparatus of the present invention.

FIGS. 8a to 8e illustrates schematic views of the arrangement of magnets in the vehicle-mounted wireless charging apparatus of the present invention.

FIGS. 9a to 9c illustrate schematic views of a micro suction mechanism to attach the mobile phone to the wireless charging apparatus of the present invention.

### DETAILED DESCRIPTION OF THE EMBODIMENTS

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

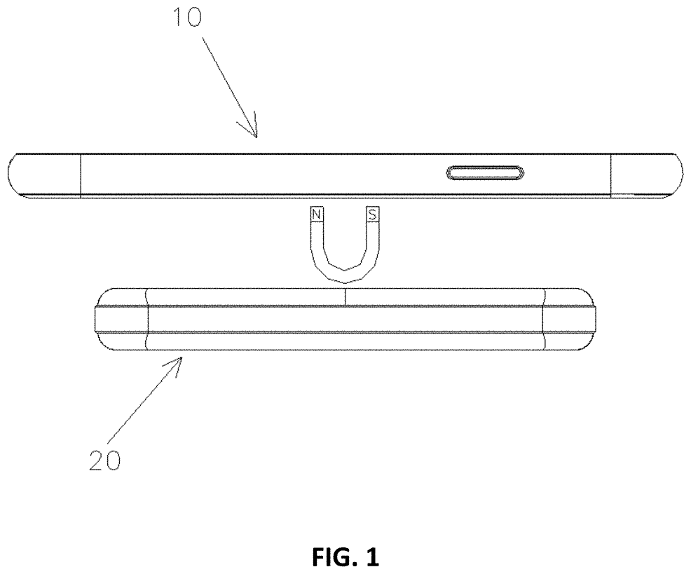

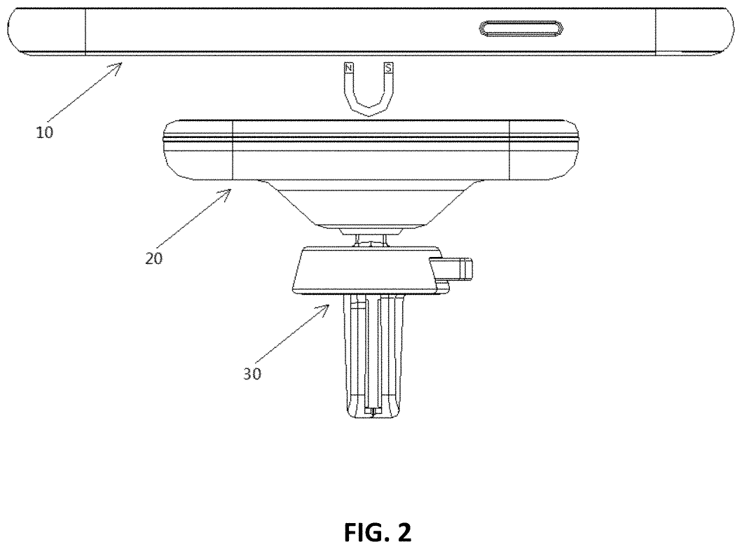

Referring to FIG. 1 to FIG. 6, a structure for stabilizing wireless charging performance, comprising a power supply, a first wireless charging transmitter 20 and a first wireless charging receiver 10, wherein the power supply supplies power to the entire first wireless charging transmitter 20, and the first wireless charging transmitter 20 comprises a circuit board 206, a first wireless transmitting coil 203, a first magnet 201 and a first metal cover 202, wherein the circuit board 206 is connected to the first wireless transmitting coil 203, the periphery of the first magnet 201 is sleeved with the first metal cover 202 and is connected with the first metal cover 202, the first wireless charging receiver 10 comprises a first wireless receiving coil, a second magnet 101 and a second metal cover 102, the periphery of the second magnet 101 is sleeved and connected with the second metal cover 102, the first wireless charging receiver 20 is snap-connected to the first wireless charging receiver 10 via the first magnet 201 and the second magnet 101, and the first wireless transmitting coil 203 coordinates with the first wireless receiving coil to wirelessly charge the first wireless charging receiver 10.

The structure for stabilizing wireless charging performance in this invention can achieve the following beneficial effects: for the structure for stabilizing wireless charging performance, the periphery of the first magnet 201 is sleeved with a first metal cover 202, making the magnetic field generated by the first wireless charging transmitter 20 not to interfere with the magnetic field generated by the first magnet 201; and the periphery of the second magnet 101 is sleeved with a second metal cover 102, making the magnetic field generated by the first wireless charging receiver not to interfere with the magnetic field generated by the second magnet 101, thereby stabilizing the wireless charging performance of the product.

In one embodiment, the first metal cover 202 and the second metal cover 102 each comprise a bottom cover, a side wall and a top cover, the side wall is disposed between the bottom cover and the top cover, and the bottom cover, the side wall and the top cover are integrally formed. The magnet adopts a fully enclosed package, so that the magnetic field generated by the coil and the magnetic field of the magnet will not interfere with each other, thus stabilizing the product's wireless charging performance.

In one embodiment, the first metal cover 202 and the second metal cover 102 each comprise a bottom cover and a side wall, and the bottom cover and the side wall are integrally formed. The magnet adopts a semi-enclosed package, so that the magnetic field generated by the coil and the magnetic field of the magnet will not interfere with each other, thus stabilizing the product's wireless charging performance.

In one embodiment, the bottom cover is disposed near one end of the first wireless transmitting coil 203; and the bottom cover is disposed near one end of the first wireless receiving coil. The first metal cover 202 and the second metal cover 102 are opposite to each other in the opening direction, so that the magnetic field generated by the coil and the magnetic field of the magnet will not interfere with each other, thereby stabilizing the wireless charging performance of the product; in addition, the first magnet 201 and the second magnet 101 have very excellent adsorption functions.

In one embodiment, the material of the first metal cover 202 is steel or iron or aluminum or copper or zinc; the material of the second metal cover 102 is steel or iron or aluminum or copper or zinc.

In one embodiment, the number of the first magnets 201 is equal to the number of the second magnets 102, and the number of the first magnets 201 is one or more.

In one embodiment, the number of the first magnets 201 is equal to the number of the second magnets 102, and the number of the first magnets 201 is four. The positions of the first magnets 201 completely correspond to the positions of second magnets 101, which are arranged in a matrix, and the first magnet 201 and the second magnet 101 both have circular cross-sections.

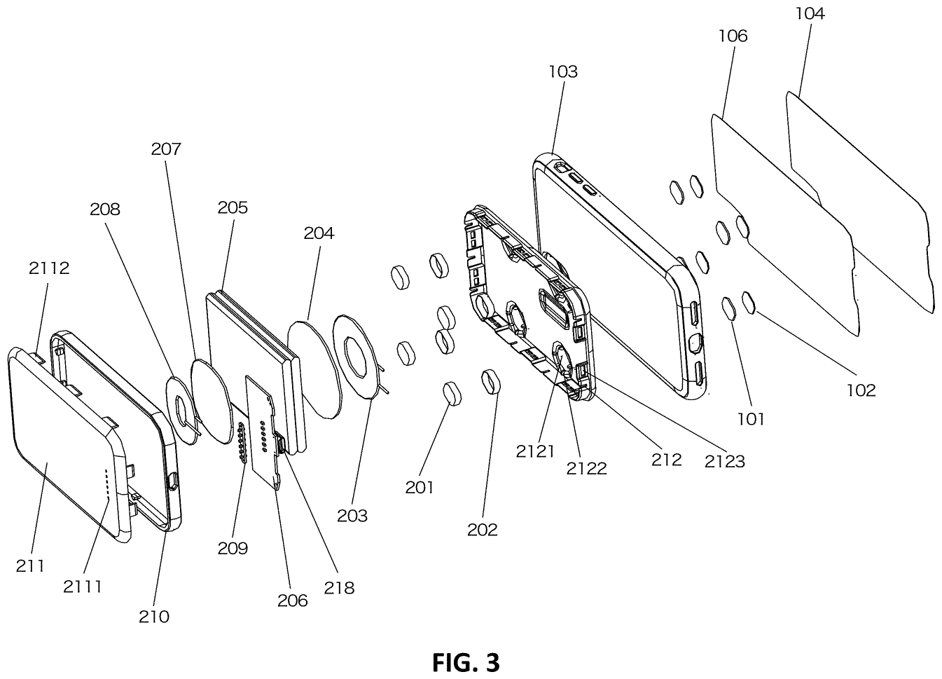

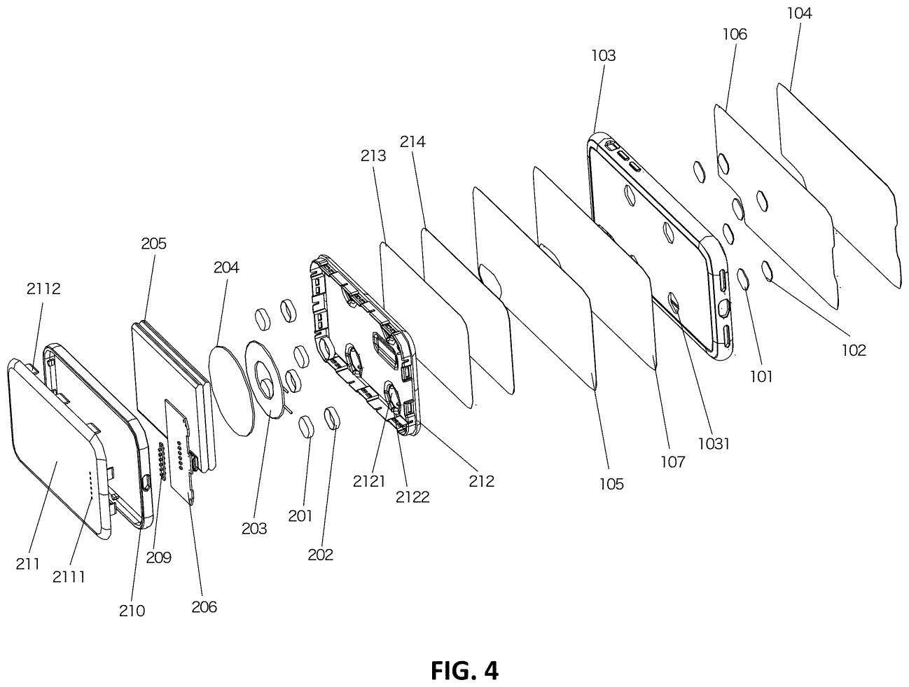

Referring to FIG. 3 and FIG. 4, another object of the present invention is to provide a wireless charging apparatus, comprising a structure for stabilizing wireless charging performance as foregoing described and a wireless charging housing, wherein a battery 205 is provided in the wireless charging housing, the power supply supplies electricity to the battery 205, the battery 205 is electrically connected to the first wireless transmitting coil 203, the first magnet 201 and the first metal cover 202 are disposed on a surface shell of the wireless charging housing, and the first wireless charging receiver 10 comprises an electronic equipment for receiving wireless charging and a housing 103 for accommodating the electronic equipment, wherein the first wireless receiving coil is disposed in the electronic equipment, and both the second magnet 101 and the second metal cover 102 are disposed on a bottom plate of the housing 103.

The wireless charging apparatus provided in this embodiment can achieve the beneficial effect: the periphery of the first magnet 201 is sleeved with a first metal cover 202, and the periphery of the second magnet 101 is sleeved with a second metal cover 101. When the structure is applied to this embodiment, it stabilizes the wireless charging performance of the product.

In one embodiment, the wireless charging housing is further provided with a second wireless receiving coil 208 corresponding to a second wireless transmitting coil in the external second wireless charging transmitter, the second wireless receiving coil 208 is electrically connected to the circuit board 206, and the second wireless receiving coil 208 coordinates with the ssecond wireless receiving coil to wirelessly charge the battery inside the first wireless charging transmitter 20.

In one embodiment, the wireless charging housing is further provided with a second magnetic sheet 207, and the second magnetic sheet 207 is connected between the second wireless receiving coil 208 and the circuit board 206. The second magnetic sheet 207 can function as a magnetic shield so that the magnetic field generated by the second wireless receiving coil 208 that is connected to the second magnetic sheet 207 is only used to receive the wireless charging signals transmitted by the second wireless charger.

In one embodiment, the wireless charging housing is further provided with a third magnet, and the third magnet is snap-connected to a fourth magnet inside the second wireless charging transmitter.

In one embodiment, the wireless charging housing is further provided with a power input interface 218, and the power supply supplies electricity to the battery 205 via the power input interface 218.

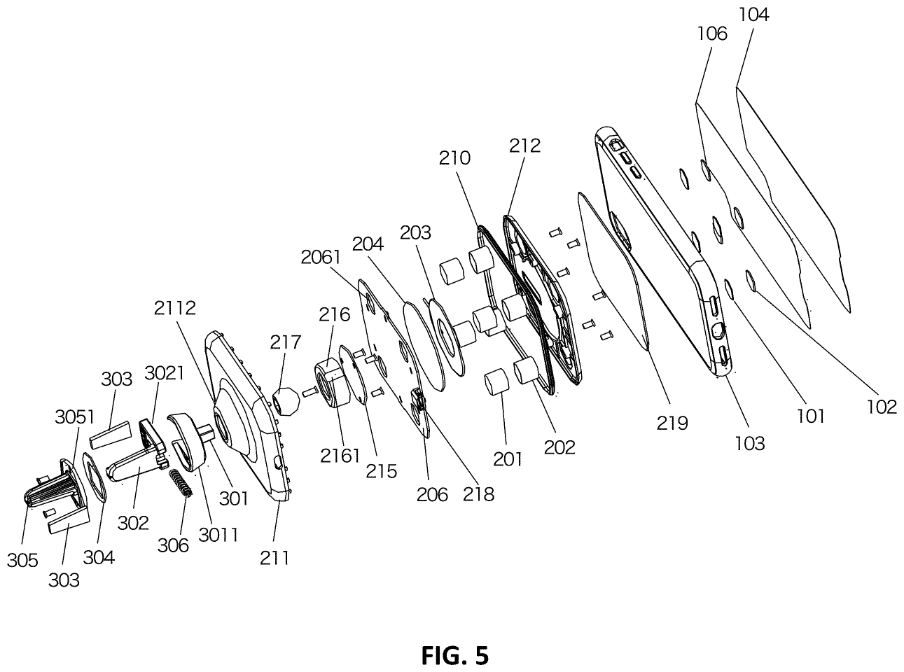

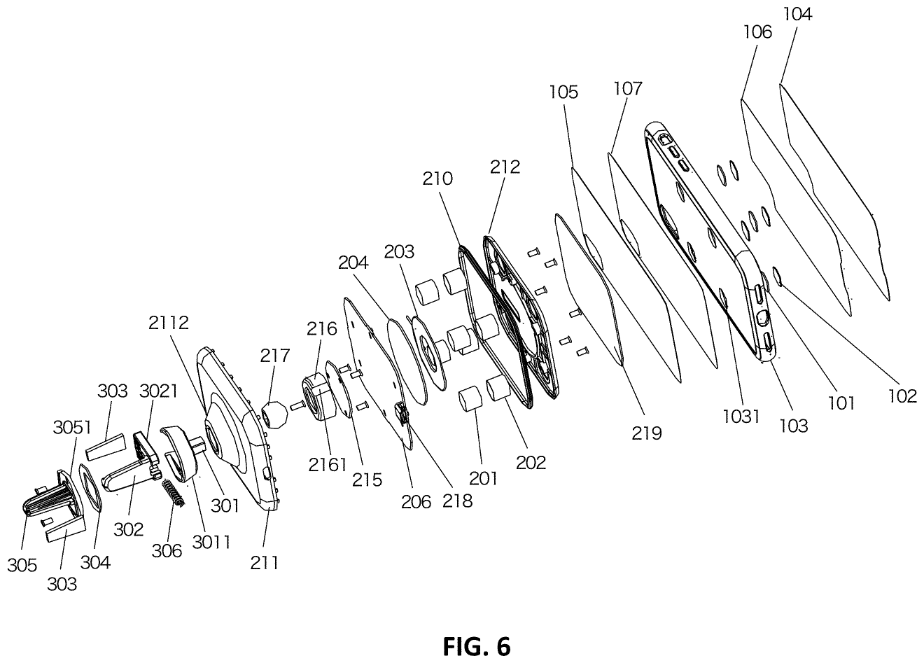

Referring to FIG. 5 and FIG. 6, another object of the present invention is to provide a vehicle-mounted wireless charging apparatus, comprising the structure for stabilizing wireless charging performance as foregoing described, a wireless charging housing and a base 30, wherein the base 30 comprises a connecting shaft 301 and a spring clip connected to a vehicle, the connecting base 301 is connected with the spring clip, a rotating shaft 217 is arranged at the bottom shell 211 of the wireless charging housing, and the connecting shaft 301 is connected with the rotating shaft 217; a power input interface 218 is disposed in the wireless charging housing, the power supply charges the first wireless transmitting coil 203 via the power input interface 218, the first magnet 201 and the first metal cover 202 are both disposed on the surface shell 212 of the wireless charging housing, and the first wireless charging receiver 10 comprises an electronic equipment for receiving wireless charging and a housing 103 for accommodating the electronic equipment, the first wireless receiving coil is disposed in the electronic equipment, the second magnet 101 and the second metal cover 102 are both disposed on the bottom plate of the housing 103.

The vehicle-mounted wireless charging apparatus provided in this embodiment can achieve the beneficial effect: the periphery of the first magnet 201 is sleeved with a first metal cover 202, and the periphery of the second magnet 101 is sleeved with a second metal cover 101. When the structure is applied to this embodiment, it stabilizes the wireless charging performance of the product.

In one embodiment, the rotating shaft 217 is sleeved with a plastic ring 216 and is connected with a plastic ring 216 to which a positioning piece 215 is attached. Further, the rotating shaft 217 is connected with the plastic ring 216 through a screw; further, the periphery of the plastic ring 216 is provided with a recess 2161 corresponding to a screw rod of a screw. After the screw passes through the screw hole on the positioning piece 215, the screw rod is placed in the recess 2161; further, there is three recesses; further, the material of rotating shaft 217 is plastic.

In one embodiment, the bottom shell 211 is provided with a concave member 2112 and a concave member connecting hole is provided in the concave member 2112, and a rotating shaft connecting hole provided on the rotating shaft 217 is disposed in the concave member connecting hole and connected with the connecting hole of the concave member 2112.

In one embodiment, the spring clip comprises a spring 306, a first card slot 302, and a second card slot 305. The first card slot base 3021 of the first card slot 302 is disposed in the connecting base 3011 of the connecting shaft 301. The first card slot base 3021 is connected with the connecting base 30211 by a spring 306. The first card slot base 3021 is provided with a washer 304, and the second card slot base 3041 of the second card slot 305 is disposed on the washer 304 and connected to the connecting base by a screw. Further, the washer 304 is made of silicone.

In one embodiment, the first card slot 302 is provided with a gasket 303 and connected to the gasket 303. A gasket 303 is also disposed on the second card slot 304 and is connected to the gasket 303. Further, gasket 303 is made of silicone.

In one embodiment, a first hole 2121 is disposed on the surface shell 212. The first magnet 201 is disposed in the first hole 2121 and is snap-connected by a protrusion 2122 provided around the first hole 2121. The outer side wall of the surface shell 212 is provided with a first plastic sheet 214, and the first plastic sheet 214 covers the first magnet 201 and connects with the outer side wall of the surface shell 212 through a first double-sided tape 213.

In one embodiment, one end of the first magnet 201 is connected to the surface shell 212, and the other end of the first magnet 201 passes through a second hole 2061 provided on the circuit board 206, the second magnet 201 passes through the second hole 2061 and is connected to the circuit board 206.

In one embodiment, the wireless charging housing further comprises a middle frame 210. The middle frame 210 is sleeved on the joint between the bottom shell 211 and the surface shell 212. The bottom shell 211 is connected with the surface shell 212 by screws. Further, a silicone sheet is attached to the outer side wall of the surface shell 212, and the silicone sheet 219 covers the screw and connects with the surface shell 212. The setting of silicone sheet 219 is used for covering the screw, making the entire surface shell more concise.

In one embodiment, the wireless charging housing further comprises a middle frame 210, a card slot 2123 is disposed on the surface shell 212, a buckle 2112 is disposed on the bottom shell 211, a card slot 2112 is snap-connected with the buckle 2123, and a middle frame 210 is sleeved on the surface shell 212 and connected with the surface shell 212.

In one embodiment, the second magnet 101 is disposed on the inner side wall of the bottom plate of the housing 103, the second magnet 101 is connected to the inner side wall of the bottom plate, and a flannel 104 is disposed on the inner side wall of the bottom plate. The flannel 104 covers the second magnet 101 and connects with the inner side wall of the bottom plate. Further, the flannel 104 is connected to the inner side wall of the bottom plate by the second double-sided tape 106.

In one embodiment, the bottom plate of the housing 103 is provided with a third hole 1031. The second magnet 101 is disposed in the third hole 1031 and connected to the bottom plate. The inner wall of the bottom plate is provided with a flannel 104. The flannel 104 covers one end of the second magnet 101 and is connected with the inner side wall of the bottom plate. The outer side wall of the bottom plate is provided with a second plastic sheet 105, which covers the other end of the second magnet 101 and is connected with the outer side wall of the bottom plate. Further, the flannel 104 is connected to the inner side wall of the bottom plate by the second double-sided tape 106, and the second plastic sheet 105 is connected with the outer side wall of the bottom plate by the third double-sided tape 107.

In one embodiment, a first magnetic sheet 204 is disposed inside the wireless charging housing, and the first magnetic sheet 204 is connected between the first wireless transmitting coil 203 and the circuit board 206. The setting of the first magnetic sheet 204 can function as a magnetic field shield so that the magnetic field generated by the first wireless transmitting coil 203 that is connected to the first magnetic sheet 204 is transmitted to the electronic equipment.

In one embodiment, a light guide post 209 is provided in the first wireless charging transmitter. The light guide post 209 is connected to the circuit board 206. The bottom shell 211 is provided with a light guide post hole 211. The light guide post 209 passes out of the light guide post hole 211 and is connected to the bottom shell 211. The function of the light guide post 209 is to transmit luminescent source so that the light source in one position is guided to another position.

In one embodiment, the electronic equipment is a mobile phone that can receive wireless charging and the housing 101 is a mobile phone shell that matches the mobile phone.

In one embodiment, the electronic equipment is a flat panel that can receive wireless charging, and the housing 101 is a flat panel shell that matches with the flat panel.

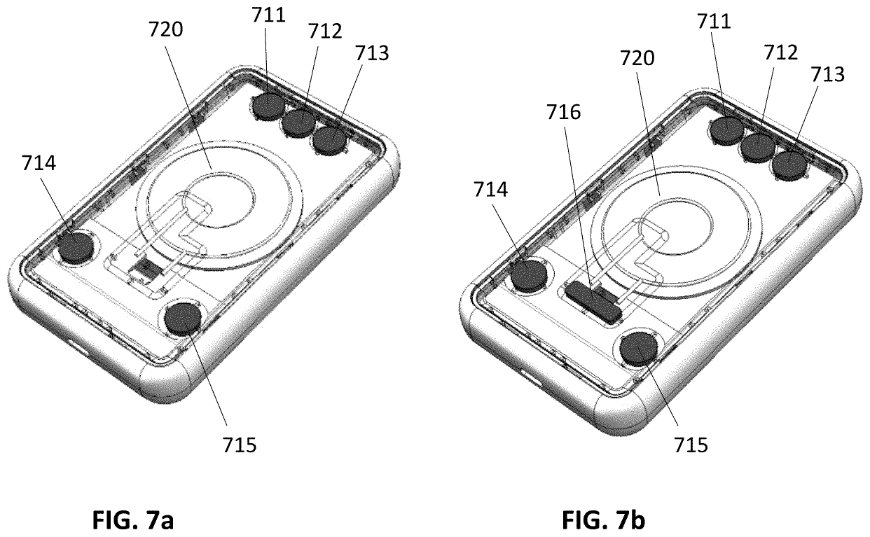

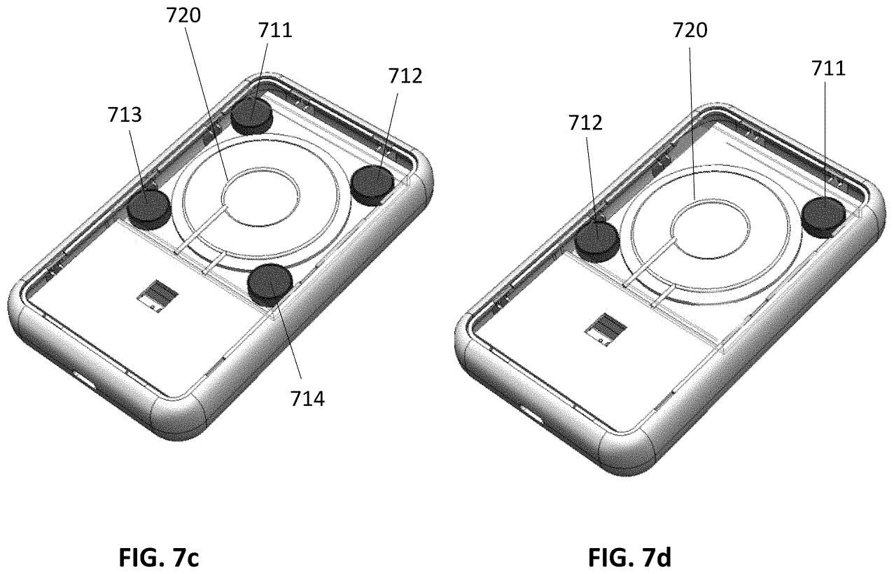

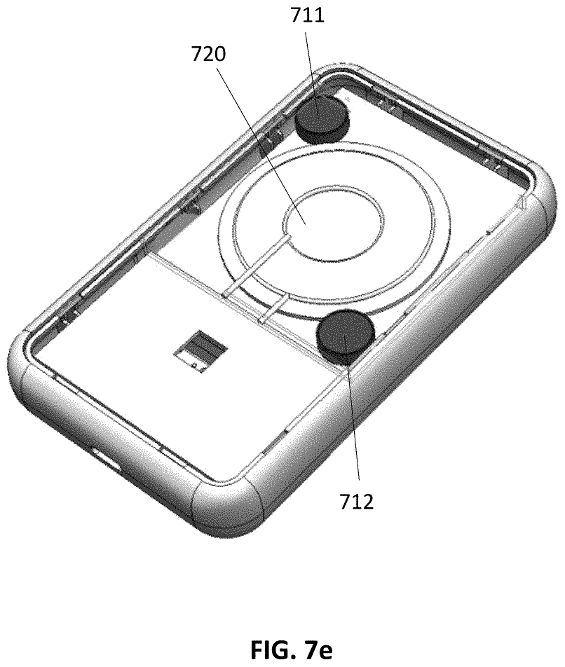

In another aspect, as shown in FIGS. 7a to 7e, the present invention provides a wireless charging apparatus having one or more magnets that can be strategically arranged to increase the stability of wireless charging and to avoid interfering with the magnetic field generated by the coil in the wireless charging apparatus. As shown in FIG. 7a, three magnets 711 to 713 can be disposed on top of the coil 720, while the other two 714 and 715 are disposed therebelow. An elongated magnet 716 can also be disposed between magnets 714 and 715 as shown in FIG. 7b.

In one embodiment, the magnets 711 to 714 can be disposed at four corners of the coil 720 as shown in FIG. 7c. In another embodiment, two magnets 711 and 712 are sufficient to provide stable wireless charging. As shown in FIG. 7d, two magnets 711 and 712 can be disposed at top left corner and bottom right corner, while they can be disposed at top right corner and bottom left corner as shown in FIG. 7e.

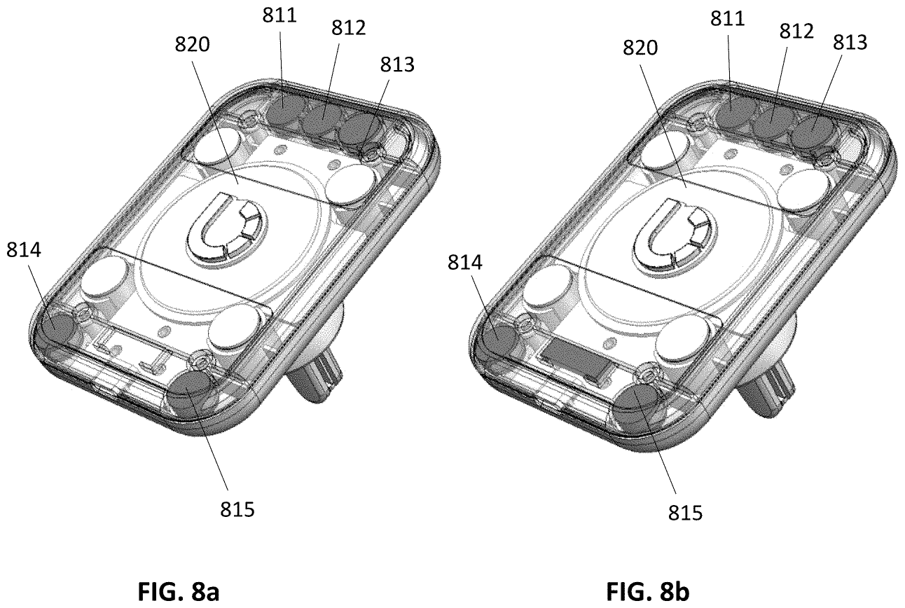

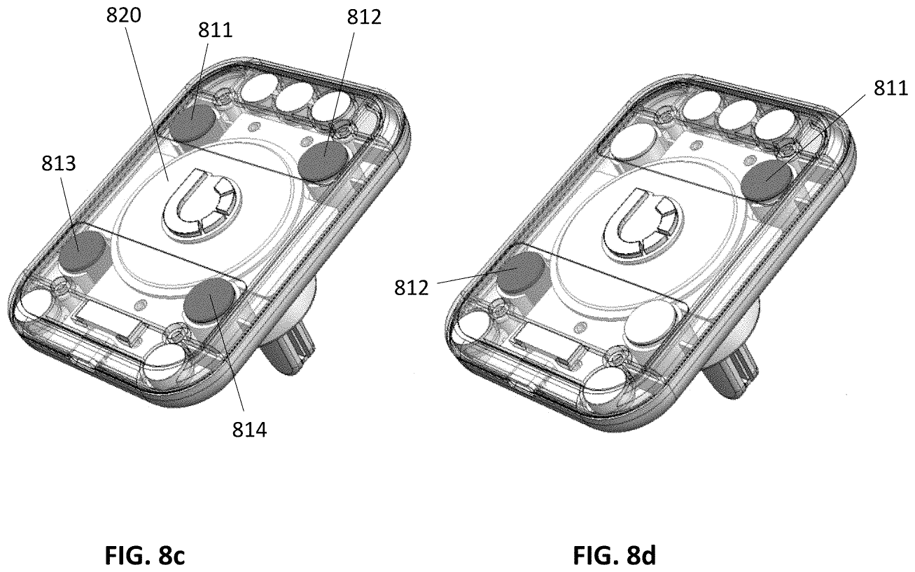

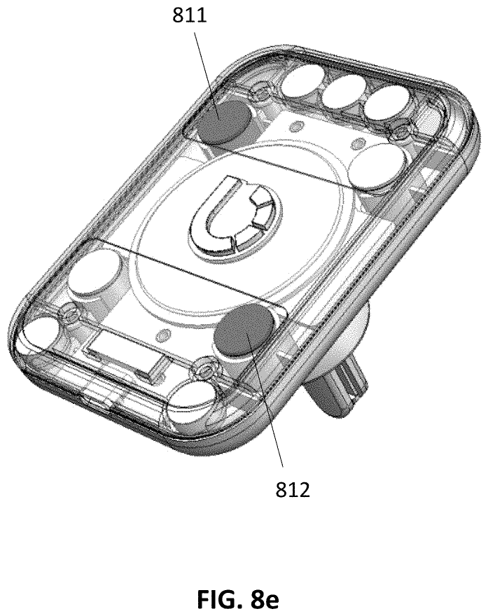

In a further aspect, as shown in FIGS. 8a to 8e, the present invention provides a vehicle-mounted wireless charging apparatus having one or more magnets that can be strategically arranged to increase the stability of wireless charging and to avoid interfering with the magnetic field generated by the coil in the wireless charging apparatus. As shown in FIG. 8a, three magnets 811 to 813 can be disposed on top of the coil 820, while the other two 814 and 815 are disposed therebelow. An elongated magnet 816 can also be disposed between magnets 814 and 815 as shown in FIG. 8b.

In one embodiment, the magnets 811 to 814 can be disposed at four corners of the coil 820 as shown in FIG. 8c. In another embodiment, two magnets 811 and 812 are sufficient to provide stable wireless charging. As shown in FIG. 8d, two magnets 811 and 812 can be disposed at top left corner and bottom right corner, while they can be disposed at top right corner and bottom left corner as shown in FIG. 8e.

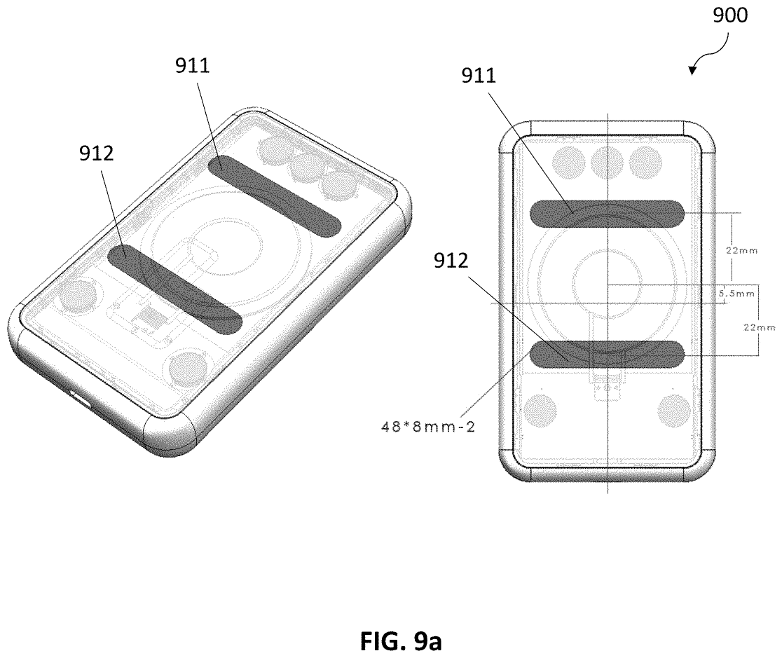

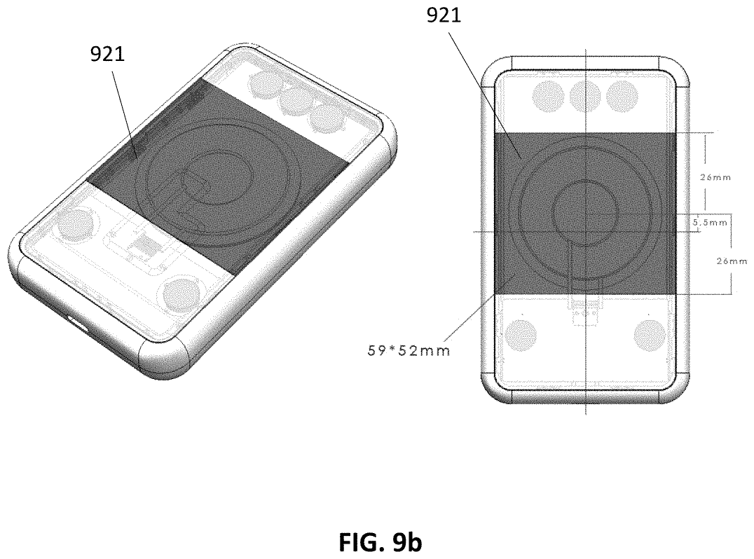

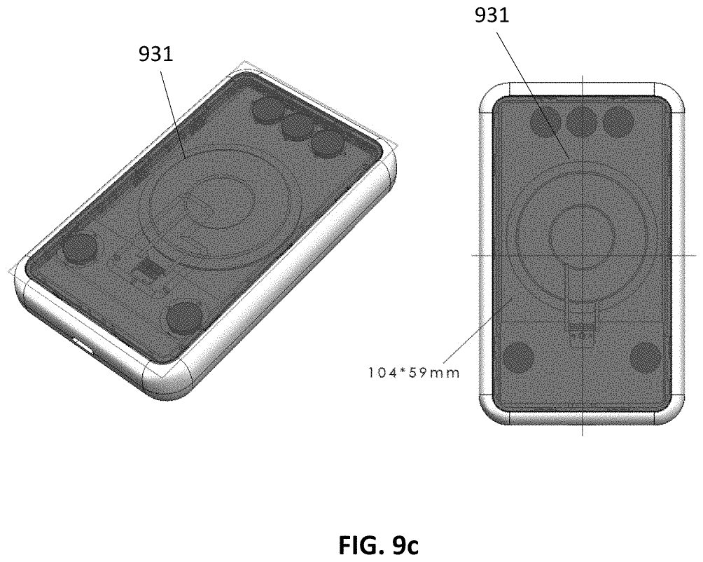

In a further embodiment, the mobile phone can be attached to the wireless charging apparatus through micro suction as shown in FIGS. 9a to 9c. More specifically, as shown in FIG. 9a, a pair of elongated stripes 911 and 912 on a front surface of a wireless charging apparatus 900 are used for attaching a mobile device to the front surface of the wireless charging apparatus 900 through micro suction. Alternatively, the elongated stripes can be expanded to a wider piece 921 to provide a stronger suction force to the mobile device. In still an alternative embodiment, the entire front surface 931 can be used for micro suction to hold the mobile device on the wireless charging apparatus 900.

It is important to note that the power providing mechanism in wireless charging apparatus illustrated in FIGS. 7a to 7e and 9a to 9c is different from the that in FIGS. 8a to 8e. More specifically, since the wireless charging apparatus in FIGS. 8a to 8e is used in a vehicle, the wireless charging apparatus may further include a charging cable connected to a power source in the vehicle. However, the wireless charging apparatus described in FIGS. 7a to 7e and 9a to 9c may be portable along with the user, so the wireless charging apparatus may further include a rechargeable battery therein as the power source.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. An apparatus for stabilizing wireless charging performance comprising a power source, a first wireless charging transmitter, and a first wireless charging receiver, wherein the power source supplies power to the whole first wireless charging transmitter, and the first wireless charging transmitter comprises a circuit board, a first wireless transmitting coil, a first magnet, and a first metal cover, the circuit board is connected to the first wireless transmitting coil, and the periphery of the first magnet is sleeved with the first metal cover and is connected with the first metal cover, the first wireless charging receiver comprises a first wireless receiving coil, a second magnet, and a second metal cover, the periphery of the second magnet is sleeved with the second metal cover and is connected with the second metal cover, the first wireless charging transmitter is connected with the first wireless charging receiver via locating snap-in connection by the first magnet and the second magnet, the first wireless transmitting coil cooperates with the first wireless receiving coil to wirelessly charge the first wireless charging receiver.

2. The apparatus for stabilizing wireless charging performance of claim 1, wherein the first metal cover and the second metal cover both comprise a bottom cover, a side wall, and a top cover, and the side wall is disposed between the bottom cover and the top cover, the bottom cover, the side wall and the top cover are integrally molded.
